(19) United States
(12) Patent Application Publication
(10) Pub. No.: US 2009/0150294 A1
(43) Pub. Date: Jun. 11, 2009

(54) SYSTEMS AND METHODS FOR AUTHENTICATING FINANCIAL TRANSACTIONS INVOLVING FINANCIAL CARDS

(76) Inventors: Albert D. March, Toronto (CA); Matthew Goddard, Toronto (CA)

Correspondence Address: BERESKIN AND PARR, 40 KING STREET WEST, BOX 401, TORONTO, ON, M5H 3Y2, CA

(21) Appl. No.: 12/330,107

(22) Filed: Dec. 8, 2008

Related U.S. Application Data
(63) Continuation-in-part of application No. 12/062,624, filed on Apr. 4, 2008.
Application No. 12/062,624 is a continuation of application No. 09/874,042, filed on Jun. 6, 2001, now Pat. No. 7,356,505.
(60) Provisional application No. 60/209,579, filed on Jun. 6, 2000.

(51) Int. Cl. G06Q 40/00; G01S 1/00; H04L 9/00

(52) U.S. Cl. 705/67; 705/35; 342/357.09

(57) ABSTRACT

A system for authenticating financial transactions comprising a plurality of financial cards, a plurality of financial terminals, and at least one authorization center connected to the plurality of financial terminals. Each of the financial cards having a card data storage device for storing identification data, and a GPS module for generating geographical position indicative of a current geographical position of the financial card. Each of the financial terminals having a card reader configured to receive one of the financial cards and access the identification data and geographical position data associated therewith. The Authorization center is configured to receive transactional data associated with a financial transaction, the transactional data including the identification data and the geographical position data for the particular financial transaction involving a particular financial terminal and a particular financial card, and for each financial transaction, determine whether that transaction is potentially fraudulent based on an analysis of the geographical position data for that transaction and previously stored geographical position data related to the particular financial card.

This application is a continuation-in-part of U.S. patent application Ser. No. 12/062,624, filed Apr. 4, 2008, which is a continuation of U.S. patent application Ser. No. 09/874,042, filed Jun. 6, 2001, which claims the benefit of U.S. Provisional Patent Application No. 60/209,579 filed Jun. 6, 2000.

### FIELD

The embodiments described herein relate generally to systems and methods for authenticating financial card based transactions.

### BACKGROUND

Financial cards are commonly used for authorization of payments at point of sale (POS) terminals. Users of said cards are often required to provide a signature so that a record is kept for future authentication purposes.

There are many known security problems with the magnetic strip technology where counterfeiting and cloning of the card may be undertaken with relative ease. As a result of the security problems associated with conventional financial cards, a CHIP and PIN standard has been developed. The CHIP and PIN based cards require the user to enter a PIN every time the card is in use. However, such cards are still prone to fraud or counterfeiting activities by those who attempt to lift the PIN when it being entered by a user.

Accordingly there is a need in the art for improved systems and methods for authenticating financial transactions involving financial cards.

### SUMMARY OF THE INVENTION

One aspect of the present invention is a financial card, comprising a card body configured to be received in a card reader of a financial terminal, a card data storage device secured to the card body for storing identification data for identifying the financial card, the identification data being accessible by the card reader when the card body is received in the card reader, a GPS receiver secured to the card body for receiving GPS signals from GPS satellites, a microprocessor secured to the card body and coupled to the GPS receiver for processing the GPS signals to generate geographical position data indicative of a geographical position of the card body, and a communication interface secured to the card body for providing the card reader with access to the geographical position data when the card body is received in the card reader.

Another aspect of the present invention is a method for detecting a potentially fraudulent financial transaction. The method comprising the steps of receiving a financial card in a card reader of a financial terminal, the financial card having a GPS module for generating geographical position data indicative of the current geographical location of the financial card; accessing the geographical position data from the GPS module; communicating the geographical position data to an authorization center; analyzing the geographical position data and, based on the analysis of the geographical position data, generating an authorization signal indicating whether the transaction is potentially fraudulent and denying the transaction based on the authorization signal if the transaction is potentially fraudulent.

Another aspect of the present invention is a method for strengthening encrypted communications between a financial card and a financial terminal. The method comprising the steps of engaging the financial card in a card reader of the financial terminal, the financial card having a GPS module for generating geographical position data indicative of the current geographical location of the financial card and a data storage device for storing card public key and a card private key correlated therewith; generating the geographical position data using the GPS module; transmitting a card public key from the financial card to the financial terminal; receiving terminal dynamic data from the financial terminal; encrypting the geographical position data and the terminal dynamic data using the card private key to generate encrypted combined dynamic data; and transmitting the encrypted combined dynamic data to the financial terminal, wherein the terminal is configured to verify the authenticity of the financial card by decrypting the received encrypted combined dynamic data using the card public key to recover the terminal dynamic data and the geographical position data.

Yet another aspect of this invention is a system for authenticating financial transactions. The system comprising a plurality of financial cards, each of the financial cards having a card data storage device for storing identification data, and a GPS module for generating geographical position indicative of a current geographical position of the financial card; a plurality of financial terminals, each of the financial terminals having a card reader configured to receive one of the financial cards and access the identification data and geographical position data associated therewith; and at least one authorization center connected to the plurality of financial terminals, the authorization center being configured to receive transactional data associated with a financial transaction, the transactional data including the identification data and the geographical position data for the particular financial transaction involving a particular financial terminal and a particular financial card, and for each financial transaction, determine whether that transaction is potentially fraudulent based on an analysis of the geographical position data for that transaction and previously stored geographical position data related to the particular financial card.

### BRIEF DESCRIPTION OF THE FIGURES

For a better understanding of the present invention and to show more clearly how it may be carried into effect, reference will now be made, by way of example, to the accompanying drawings, in which:

FIG. 1 is a block diagram of the general system architecture of one embodiment of a fund transfer system;

FIG. 2A is a schematic representation of the general data structure of the INITIATION data packet sent by the Initiating Regional Office to the Initiation Authorization Center of FIG. 1;

FIG. 2B is a schematic representation of the general data structure of the AUTHORIZATION data packet sent by the Initiating Authorization Center to the Dispensing Authorization Center of FIG. 1;

FIG. 2C is a schematic representation of the general data structure of the DISPENSING data packet sent by the Dispensing Authorization Center to the Dispensing Regional Office of FIG. 1;

FIG. 2D is a schematic representation of the general data structure of the CONFIRMATION data packet sent by the Dispensing Regional Office to the Initiation Regional Office to FIG. 1;

FIGS. 3, 4, and 5 are flow chart diagrams which illustrating one embodiment of a general process used to accomplish transfer of funds from the sender to the recipient over the fund transfer system of FIG. 1;

FIG. 6 is a schematic drawing showing the top view of the financial card of the fund transfer system of FIG. 1; and

FIG. 7 is a schematic drawing illustrating the signature generation process utilized by the financial card of the fund transfer system of FIG. 1.

FIG. 8 is a block diagram of the secure transaction system;

FIG. 9A is block diagram illustrating front view of a financial card;

FIG. 9B is a block diagram illustrating the rear view of the financial card of FIG. 9A;

FIG. 9C is perspective view of the body of the financial card of FIG. 9A;

FIG. 10 is a block diagram of the fields of the GPS locations repository;

FIG. 11 is a flowchart illustrating the steps of a location determination method;

FIG. 12 is a flowchart illustrating the steps of a transaction authentication method;

FIG. 13 is a block diagram illustrating the security public and private key components associated with the system of FIG. 8; and

FIG. 14 is a flowchart illustrating the steps of an encryption method according to another aspect of the invention.

FIG. 15 is a block diagram illustrating some steps of the encryption method of FIG. 14.

### DESCRIPTION

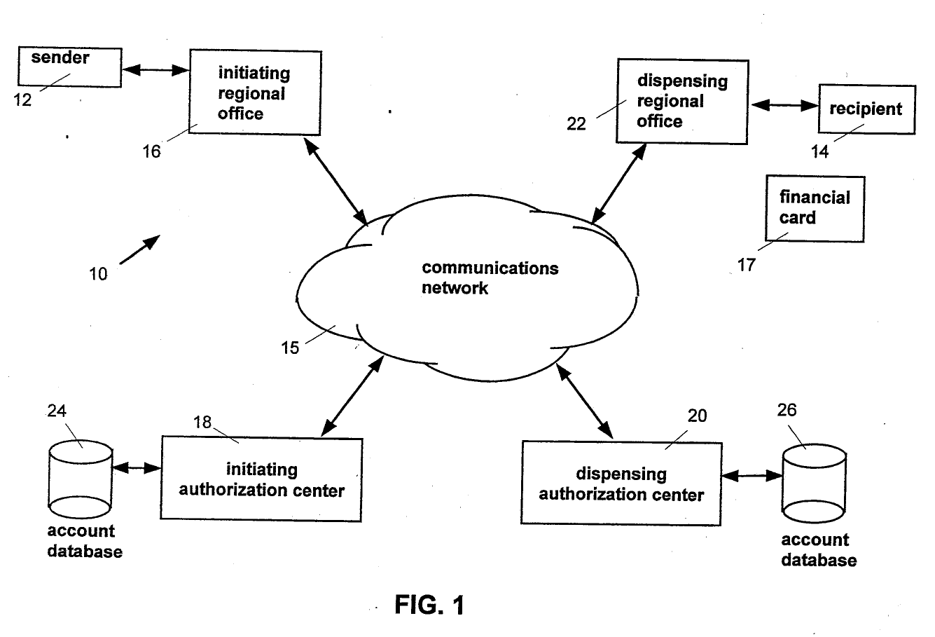

Reference is first made to FIG. 1, which shows a block diagram of fund transfer system 10 made in accordance with one embodiment of the invention and which will be used for the purposes of describing some operational aspects.

Fund transfer system 10 allows a sender 12 to transfer funds to a recipient 14 over communications network 15 (i.e. a conventionally known ATM network such as INTERAC™ or CIRRUS™) through the use of Initiation Regional Office 16, Initiating Authorization Center 18, Dispensing Authorization Center 20, and Dispensing Regional Office 22, as will be described. Specifically, sender 12 initiates the fund transfer process, which if successful results in the issuance of a secure, anonymous, ATM compatible financial card having a particular preset monetary value to recipient 14 for his or her own personal use. In respect of the implementation it should be understood that the cost to establish an electronic network similar to the existing ATM network is enormous. Thus, any solution to the problem should rely, to some extent, on the existing ATM network.

There are several ATM systems in existence in North America and around the world. These systems are interlinked such that an individual may travel to virtually any location and retrieve money from their account using a local ATM. The account is accessed by inserting a card in an ATM machine and supplying a pre-assigned Personal Identification Number (PIN). Upon verification of the PIN, the individual is provided access to their account and may withdraw funds therefrom. The ATM also allows individuals to perform various other transactions which normally requires the assistance of a teller. Such transactions may include, for example, deposits, transfers of funds between accounts in the same bank, checking account balances, etc.

The use of the ATM is facilitated by a keypad and various function keys. The keypad allows the user to enter specific numerical information, while the function keys allow quick responses to various questions or prompts. The individual may also be provided with such conveniences as the selection of a preferred language for conducting the current session at the ATM.

Regional ATM networks (which are usually shared banking cooperatives) have been developed to permit bank customers to access any ATM in their local area. Users are no longer tied to their own bank's ATMs. The Cirrus and Plus ATM networks offer the same service on a national basis by linking required ATM networks. Fund transfer system 10 generally may require no new hardware or software modifications to ATM communication systems. And unlike other home banking systems (which require specialized software or automated clearing house capability), embodiments described herein may require little or no new software or operating procedural changes at a user's bank.

Sender 12 can be an individual, or alternatively can be an individual coupled through an intermediate agent (e.g. an affiliated store or commercial outlet) to Initiating Regional Office 16. It should be understood that sender 12 may alternatively present cash to an agent, if desired. Sender 12 may be without any local banking affiliation, such as a business traveller or a student away at school. In either scenario, such an individual would contact an agent and the agent would interact with fund transfer system 10 as if the agent were sender 12. It should be noted that neither sender 12 nor recipient 14 requires a card to activate the selected ATM or any financial institution affiliation whatsoever to receive the designated funds.

Initiating Regional Office 16 is typically a branch of a financial institution (e.g. banking or credit card company) that implements fund transfer system 10. Initiating Regional Office 16 can be fully automated, wherein Initiating Regional Office 16 includes a communications device (e.g. a modem) for receiving a communication from sender 12 requesting transfer of value and for verifying the availability of funds in the account of sender 12. Specifically, Initiating Regional Office 16 can also include a computer and appropriate software to run the modem, so that it can automatically receive sender's 12 request for a fund transfer and in response thereto telephone sender's 12 bank to verify the availability of funds in the customer's account. However, a person stationed at the central server apparatus could manually receive the customer's call and then manually phone the customer's bank.

Sender 12 is securely connected to Initiating Regional Office 16 using a conventionally known communications method (e.g. through an ATM machine or over the Internet). For example, the initiator could use a touch-tone telephone with a card reader via a voice response unit to access the system services. It should be understood that the initiator could instead utilize an ATM, or a personal computer outfitted with the capability to access the system service as generally described herein.

Regardless of the mode of communication between sender 12 and Initiating Regional Office 16 (telephone, personal computer, ATM, etc.), a financial card would generally be used to make funds available from a financial account corresponding to the card. Such card could be a credit card, debit card, smart card or stored value card. At this point, the funds to be transferred are held or pre-authorized as available and sender's 12 account is also debited the amount of the customary transaction or convenience fee (which is not be returned if the transfer is not completed). A convenience fee, which is ordinarily paid by sender 12, is charged for each money transfer transaction.

According to one embodiment, fund transfer system 10 requires sender 12 to provide a verification ID protocol (i.e. a question and answer sequence) which must either be communicated by sender 12 to recipient 14 contemporaneously with the fund transfer or which has been prearranged between sender 12 and recipient 14. Recipient 14 will need to complete the verification ID protocol in order to obtain the transferred funds from Dispensing Regional Office 22. It should be understood that since the present invention contemplates the situation where recipient 14 does not have personal identification papers and the like, it will be necessary to have a memorized or pre-arranged verification ID protocol in order to provide a desired level of fund release security. It should be understood that the verification ID protocol could be supplanted with, or substituted with, another type of security identification systems which recognize an individual's biological characteristic such as a signature, thumbprint, or retina scan, etc.

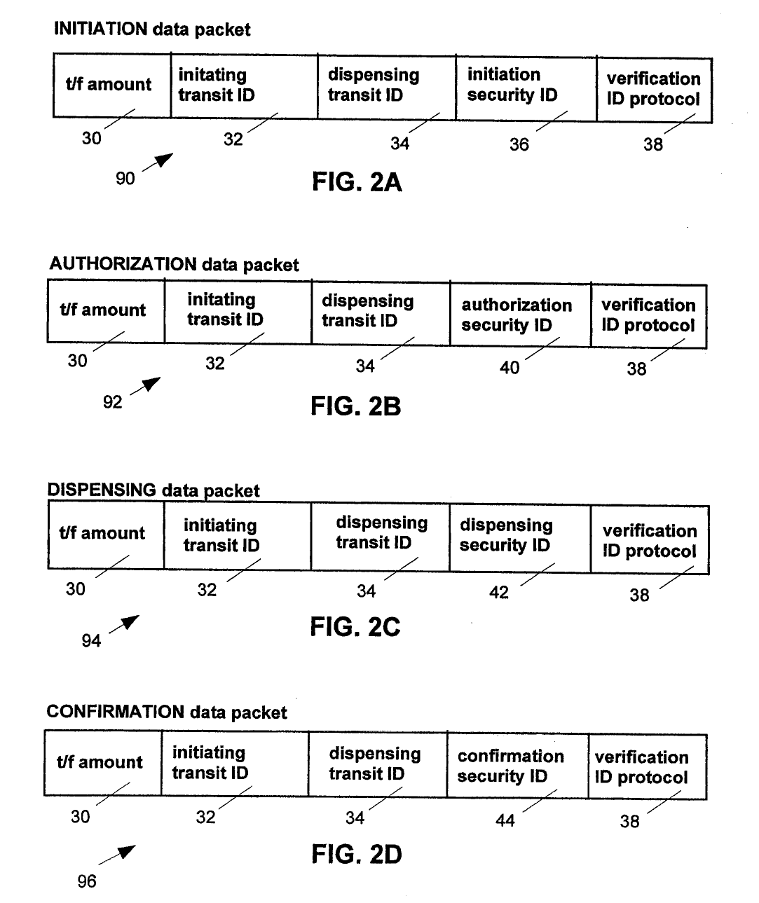

Upon verification, Initiating Regional Office 16 sends an INITIATING data packet 90 (as shown in FIG. 2A) to Initiating Authorization Center 18. As shown in FIG. 2A, Initiating Data Packet 90 contains data that represents the predetermined transfer amount 30, the initiating regional office transit number 32, the dispensing regional office transit number 34, an initiation security ID 36 and a verification ID protocol 38, which is an encoded version the verification D protocol a question answer sequence) provided sender 12. It should be understood that initiation security ID 36 could be either the personal security ID of an employee working at Initiating Regional Office 16 or an automatically generated security ID based on the specific transfer transaction.

When Initiating Authorization Center 18 receives INITIATING data packet 90 from Initiating Regional Office 16, a supervisor (i.e. an employee or a virtual or mechanized process within Initiating Authorization Center 18) will confirm the predetermined transfer amount of monies being sent, the initiation security 10 provided, and the dispensing regional office transit number. Once confirmation is generated, Initiating Authorization Center 18 will communicate with Dispensing Authorization Center 20 in the destination country or region over communication network 15 in the form of an AUTHORIZATION data packet 92 (as shown in FIG. 2B) which includes an authorization security ID 40. Data communication preferably takes place over an ATM or other digital communication network but could also take place in an analog form (e.g. by verbal communication over telephone, written communication in a fax, etc.)

Once Dispensing Authorization Center 20 receives the AUTHORIZATION data packet from Initiation Authorization Center 18, a supervisor there will confirm the authenticity of the authorization security ID and authorize the amount of money to be encoded into a financial card for recipient 14. Dispensing Authorization Center 20 will then send a DISPENSING data packet 94 (as shown in FIG. 2C) which includes a dispensing security ID 42, to Dispensing Regional Office 22. A supervisor at Dispensing Regional Office 22 will confirm the dispensing security 10 and then proceed to wait for recipient 14 to collect funds in person.

In order to complete the fund transfer, recipient 14 attends at Dispensing Regional Office 22 which is typically a banking institution or an affiliated agent. It should be understood that Dispensing Regional Office 22 could also be an ATM or some other interactive terminal (e.g. tourist banking kiosk) which has electronic funds transfer capability as described herein. Assuming recipient 14 is able to complete the verification ID protocol (i.e. sender 12 has communicated same to recipient 14 or recipient 14 knows the answer to a unique commonly known question etc.), then Dispensing Regional Office 22 will send a confirmation communication to Initiating Regional Office 16 in the form of a CONFIRMATION Data Packet 96 (as shown in FIG. 2D) which includes a confirmation security ID 44. This will cause Initiating Regional Office 16 to obtain the funds (i.e. the principle funds along with any applicable international taxes, etc.) from sender 12 and to issue recipient 14 a financial card containing the predetermined amount of funds.

According to some embodiments, and further discussed below, Dispensing Regional Office 22 has been programmed to accept input from recipient 14 without recipient 14 needing to use a financial card of any type or to have a banking of financial account of any kind. As a result, recipient 14 interacts with Dispensing Regional Office 22, without using a card, to either provide the attending staff with the appropriate verification ID protocol or to activate the appropriate menus if Dispensing Regional Office 22 is an interactive terminal. If recipient 14 provides the appropriate verification 10 protocol information that corresponds with that of the sender 12, recipient 14 will be issued a financial card which contains the pre-determined amount.

The transfer of funds (or value) from sender's 12 account to the various system accounts of fund transfer system 10 is an electronic funds transfer that occurs through a conventional automated clearinghouse fund transfer process. However, it should be understood that the present invention is not meant to be limited to a particular mechanism or process for transferring funds from the customer's to the system's account, and any known method or conventionally used method could be just as easily utilized. Although, as telecommunications technology progresses, future fund transfer systems may also be applicable for use with the present invention, such as fund transfers through the Internet.

It should also be understood that all information transferred within the system is preferably conducted using known secure encrypted means (i.e. Microsoft Wallet using regularly changing code sequences) over the Internet and/or through proprietary banking networks. Also, confirmation and verification of payment information (e.g. user transit number, employment number, authorization codes) can be accomplished either directly or through a centralized call-in center.

Finally, it should be understood that Initiating Regional Office 16, Dispensing Regional Office 22, Initiating Authorization Center 18, and Dispensing Authorization Center 20 could all be contained within one physical entity or that any number of these could be combined into one physical entity or presence. Specifically, while it is contemplated that Initiating Authorization Center 18 and Dispensing Authorization Center be located at geographically disparate locations, it is possible that they could be the same authorization center and located in tandem.

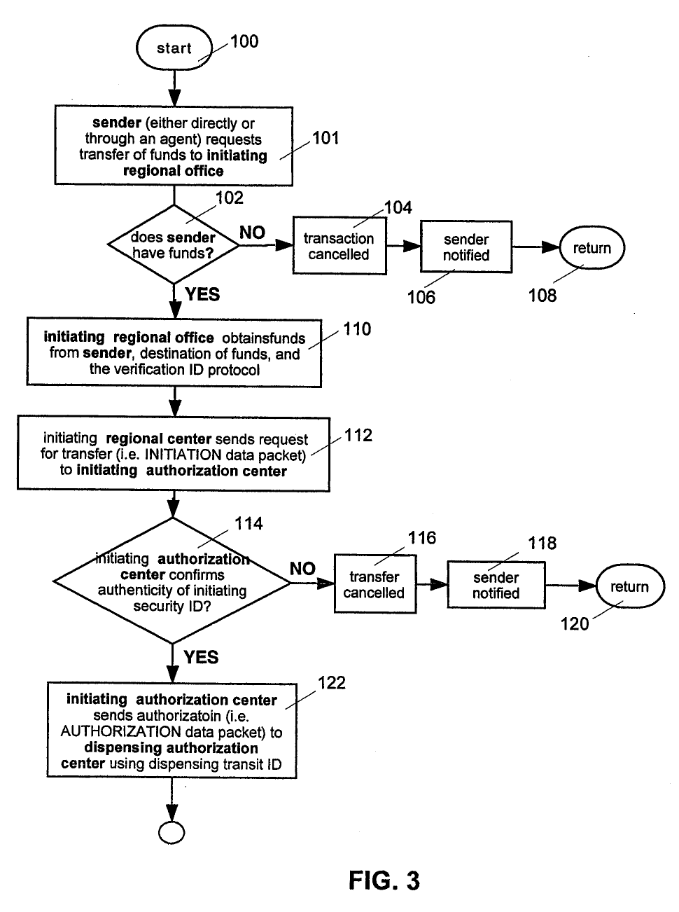

FIGS. 3, 4, and 5 are flow chart diagrams illustrating one embodiment of the general process steps used to accomplish transfer of funds from the sender 12 to the recipient 14 within fund transfer system 10.

Specifically, in FIG. 3 a transfer is first initiated (by step 100) by sender 12 who requests a fund transfer at Initiating Regional Office 16 (i.e. in person, through an intermediate agency or remotely by phone, fax, e-mail of other method of communication) (by step 101). Initiating Regional Office 16 checks to see whether sender 12 has available funds (i.e. funds plus applicable taxes etc.) for the transfer (by step 102) and if not cancels the transaction (by step 104), notifies sender 12 (by step 106) and returns (at 108). If sender 12 has sufficient funds to cover the transfer, Initiating Regional Office 16 puts a hold on the funds (i.e. holds funds in trust for sender 12), obtains a service fee which is not returned to sender 12 should the transfer fail. at Initiation Regional Office 16 and obtains destination of funds and verification ID protocol from sender 12 (by step 110) to authenticate the identity of recipient 14.

Initiation Regional Office 16 then sends a request (i.e. the INITIATION data packet 90 of FIG. 2A) to Initiation Authorization Center 18 (by step 112). This entails that a supervisor (e.g. a person or automated “virtual” supervisor) at Initiation Regional Office 16 provides an initiation security ID which can be generated by swiping an employee ID swipe card (i.e. a master key card) and entering the predetermined amount of funds to be transferred on a keypad (or in an computerized automated fashion by the “virtual” supervisor). Preferably, entered into the system computer database for transmission to Initiation Authorization Center 18 although the information could be e-mailed, phoned or faxed over secure phone lines (i.e. the existing secure e-mail, faxing line wire transfer services utilized by entities such as American Express and Western Union). It may also be prudent to have supervisor record this data into a physical location ledger or journal as backup.

The currency and validity of the various data entries in the INITIATION data packet 90 (most importantly the initiation security 10) is checked at Initiation Authorization Center 18 (by step 114). If this information is not confirmed then Initiation Authorization Center 18 cancels the transfer (by step 116), notifies sender 12 (by step 118) and returns (at 120). Otherwise, if the data in INITIATION data packet 90 is confirmed, Initiating Authorization Center 18 will send a data communication (i.e. the AUTHORIZATION data packet 92 of FIG. 2B) to Dispensing Authorization Center 20 (by step 122).

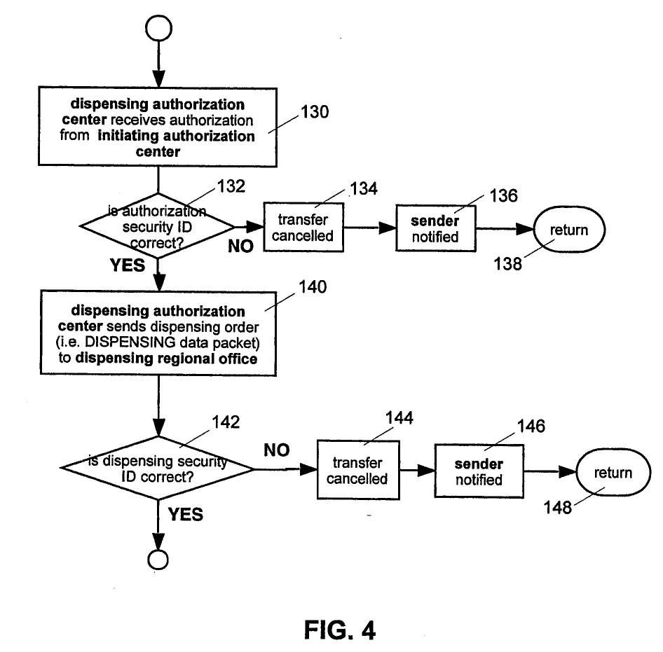

FIG. 4 illustrates a further series of general process steps which are executed within fund transfer system 10. Once Dispensing Center 20 receives AUTHORIZATION data packet 92 Initiating Authorization Office 18 (by step 130), Dispensing Authorization Center 20 checks to see whether all of the data is correct and in particular checks the validity and currency of the authorization security ID (by step 132). If any of this information in incorrect, then Dispensing Authorization Center 20 cancels the transfer (by step 134), notifies sender 12 (by step 136), and returns (by step 138).

If the AUTHORIZATION data packet 92 is confirmed to contain correct information, Dispensing Authorization Center 20 then sends a dispensing order (i.e. by forming and sending DISPENSING data packet 94 including dispensing security 10) to Dispensing Regional Office 22 (by step 140). Dispensing Regional Office 22 then determines whether the dispensing security ID is correct (by step 142) and if not then Dispensing Regional Office 22 cancels the transfer (by step 144), notifies sender 12 (by step 146), and returns (by step 148).

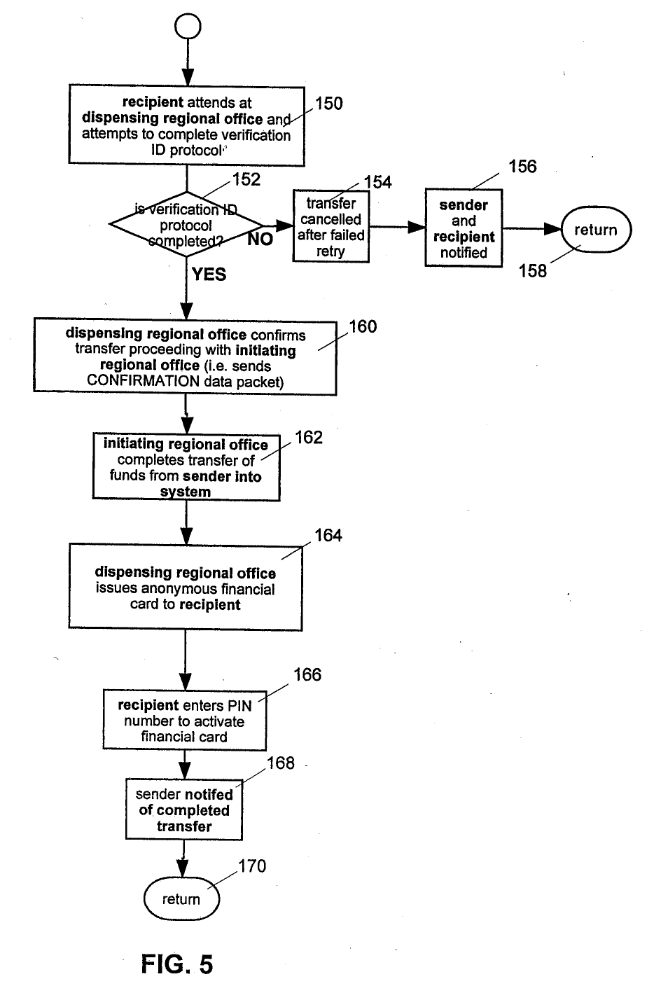

FIG. 5 illustrates a further series of general process steps which are executed within fund transfer system 10. If the DISPENSING data packet 94 is confirmed correct, then Dispensing Regional Office 22 will update its local computer records to indicate that a fund transfer is pending for intended recipient 14. Recipient 14 then attends at Dispensing Regional Office 22 (by step 150) and attempts to complete the verification ID protocol (which can potentially include but does not necessarily require the provision of personal identification papers). It should be noted that the pending arrival of a prospective transfer to recipient 14 can be held for a preset period of time and that while the prospective transfer is being held in the system, regular checks are conducted by fund transfer system 10 to ensure that sender 12 has the requisite funds available for transfer.

Dispensing Regional Office 22 then checks to see whether recipient 14 can successfully complete the verification ID protocol provided by sender 12 (by step 152) and if not then Dispensing Regional Office 22 cancels the transfer (by step 154), notifies sender 12 and recipient 14 (by step 156), and returns (by step 158). If so, then Dispensing Regional Office 22 confirms that the fund transfer is proceeding with Initiating Regional Office 16 by sending a CONFIRMATION data packet 96 (by step 160). In response, Initiating Regional Office 16 obtains the requisite funds (i.e. the principle funds plus any applicable taxes) from sender 12 (by step 162).

Dispensing Regional Office 22 then issues a secure, anonymous, ATM compatible financial card 17 having a particular preset monetary value to recipient (by step 164) using conventionally known card issuance techniques. Finally, recipient 14 selects a unique PIN number (made up at the time of issue) for future user and security purposes (by step 166). The card is then activated and serves as a pre paid ATM compatible credit/debit transaction card for recipient 14. Once the transfer has been completed, fund transfer system 10 notifies sender 12 of the completion of the fund transfer (by step 168) and returns (by step 170).

As recipient 14 uses financial card 17, fund transfer system 10 utilizes a bookkeeping functionality to keep track of usage and to deduct the appropriate amounts so that the amount of value transferred from financial card 17 does not exceed the pre-determined amount stipulated by sender 12. Generally, financial card 17 would be issued in an “open format”, but it could also be possible to issue financial card 17 in pre-set denominations. Initiating Authorization Center 18 and Dispensing Authorization Center 20 utilize the bookkeeping mechanisms that are already used by the major credit card companies. It is contemplated that fund transfer system 10 would simply be “built into” an existing credit card facility for purposes of accounting. The addition of fund transfer system 10 to an existing credit card operation would allow for the extension of fund transfers to potential clients who do not hold a credit or related bank account.

Specifically, the standard principles of credits and debits are utilized by Initiating Authorization Center 18 and Dispensing Authorization Center 20 for the purpose of reconciliation into the internal account balancing and records of fund transfer system 10. Typically, a deposit slip for monies received or a copy of receipt for monies received accompanies the actual cash or certified cheque at the bank or office of Initiating Regional Office 16. The same paper work is kept along with the data entered into the account databases 24 and 26 at Initiating Authorization Center 18 and Dispensing Authorization Center 20, respectively. This is done to keep accurate track of each usage of any issued card, and will act as a backup to the actual cards and supporting operating programs that each financial card 17 is programmed to interact with during the course of use by the user. Similar or supporting paper work is kept at the Initiating Regional Office 16 and at the Receiving Regional Office 16 where recipient 14 is issued financial card 17. It should be understood that it is possible that financial card 17 could be used for purposes of refunds of purchases by recipient 14 just as with any other standard credit card transaction. It is also contemplated that financial card 17 could be of a rechargeable format (i.e. for the life span of the associated card hardware) to allow recipient 14 to continually use for regular recharging purposes (i.e. monthly allowance or government payments, etc.)

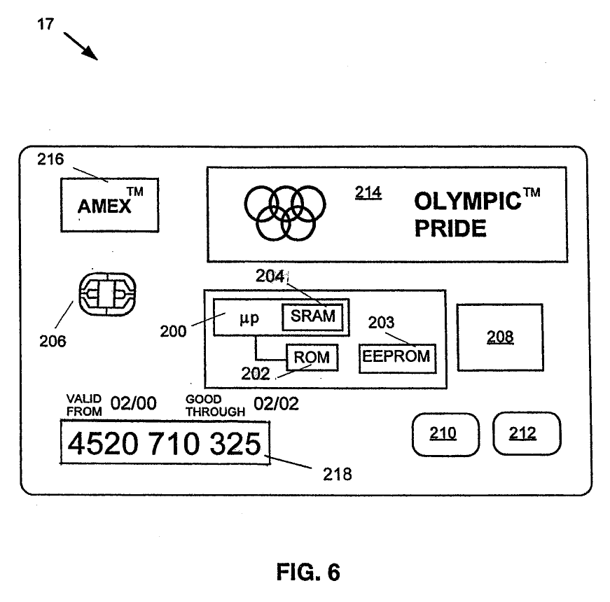

FIG. 6 depicts one side of one embodiment of financial card 17 wherein financial card 17 is a smart card. Smart cards are credit card sized devices with on-board computer chips that provide a user with the ability to carry digital cash on the chip and with the card. Smart cards are extremely convenient for various commonplace commercial financial transactions since they eliminate the need for immediate cash, and they also eliminate associated problems like making change, processing coins, as well as the potential for vandalism and fraud. While the embodiment of financial card 17 is a smart card, it should be understood that various other types of cards (i.e. debit/credit or value cards) could be used.

The development of such convenient financial instruments has also produced “smart cards” which are especially popular in Europe. Rather than employing information encoded on a magnetic strip, smart cards incorporate a microprocessor which is embedded in the card and can interact with the ATM or merchant terminal to provide information about the cardholder or the cardholder's account, transaction authorization, or other information. The wire transfer smart card disclosed in U.S. Pat. No. 5,461,217 to Claus for “Secure Money Transfer Techniques Using Smart Cards” and the smart card design and card to system interface applications described in U.S. Pat. No. 5,844,218 to Kawan et al. for “Method and System for Using an Application Programmable Smart Card for Financial Transactions in Multiple Countries” are incorporated herein by reference.

Referring back to FIG. 6, financial card 17 includes an ISO 7816 interface 206, a hologram 208, buttons 210 and 212, an LCD Screen 214, and an advertisement placement space 216. Financial card 17 displays various menus on the LCD Screen 214 and recipient 14 may select menu options and provide other input to financial card 17 through the buttons 210 and 212. Finally, a specific anonymous card number can be printed on a card number space 218. It should be understood that this is just one possible interface and that many other types of user interfaces are possible.

It is contemplated that advertisement placement space 216 on financial card 17 could be used to provide either the logo of the issuer (i.e. a major credit card company) or the logos of an affiliated organization (e.g. NBA™, OLYMPIC™ sponsorship, etc.) with similar layout to standard issued credit cards. Sponsorships could be established to offset associated costs (i.e. ATM fees) for certain individuals (e.g. seniors). It should also be understood that the specific functionality of financial card 17 will depend on which internal network interfacing software is used (i.e. where it should be an INTERAC™ and/or CIRRUS™ compatible card) and that is could be possible to include a magnetic strip on the back of financial card 17 for additional functionality.

Financial card 17 has a thin sheet material body with an approximate length and width of a standard credit card or smaller for user convenience. However, unlike conventional credit cards, financial card 17 has a microprocessor 200 (shown in dotted outline) implemented by a 32-bit, 5 MHz IBM RISC processor with 5V DC generator manufactured by IBM. Storage of program instructions and other static data is provided by read only memory (ROM) 202 (e.g. 96 kilobytes ROM) and EEPROM 203 (e.g. 64 kilobytes EEPROM) while storage of dynamic data is provided by a random access memory (SRAM) 204 (e.g. 5 kilobytes SRAM). All memory units 202, 203 and 204 are accessed by microprocessor 200 using a 32-bit PCI bus interface and a high-speed USB interface is also provided It should be understood that microprocessor 200 may be implemented by any commercially available programmable/memory devices having suitable memory, speed and dimensions for use within financial card 17.

Microprocessor 200 is programmed to implement data processing which complies with the Federal information Processing Standards (FIPS) namely FIPS 140-1, Level 3. Microprocessor 200 also contains a fast math coprocessor (4096-bit modules) and is programmed to implement various encryption algorithms such as DES, Triple DES and Skipjack as well as key exchange algorithms RSA, Diffie-Hellman, KEA. Microprocessor 200 also provides symmetric and asymmetric key generation on card and supports various cryptographic algorithms including RSA, DSA, DES, Triple DES, SHA-1 and MD5. The specific encryption and key generation techniques utilized by financial card 17 are selected according to the type of specific security concerns associated with implementation and operational speed requirements.

For example, in respect of providing an appropriate signature algorithm for financial card 17, it has been determined that while DES and Triple DES algorithms provide high speed encryption and decryption, they are too insecure for proper use in association with financial card 17, especially where financial card 17 is used over large scale public communication networks. Accordingly, the RSA key exchange algorithm is preferably used to provide an adequate level of security. As conventionally known, the RSA key exchange algorithm utilizes public and private key pairs which are both very large prime numbers. The RSA algorithm is based on the difficulty of factoring the product of these two large prime numbers. The public key consists of a modulus m and a public exponent e. The private key consists of the same modulus m and a private exponent d. The two keys are generated from two randomly chosen large prime numbers p and q according to the relation:

m=pq

For security reasons, the lengths of these two numbers are equal. A modulus size of 1024 bits is considered to offer a reasonable level of security for applications like digital signatures. After further conventionally known calculations, factoring e and introducing x as plaintext and y as ciphertext, the formulas for encryption and decryptions are:

y=xe mod m and

x=yd mod m, respectively.

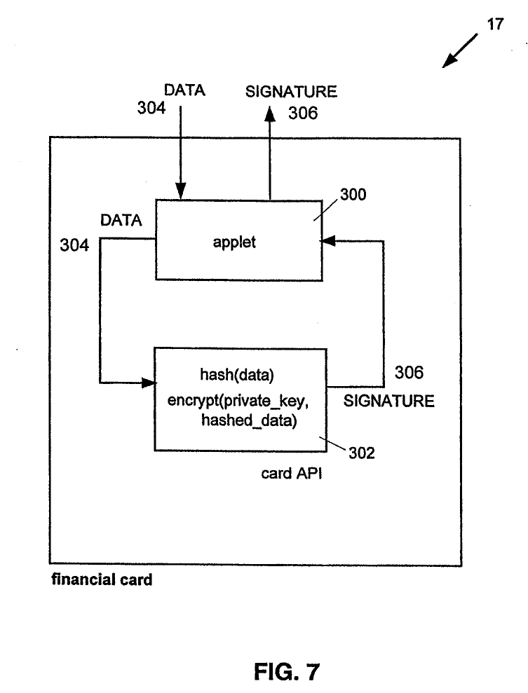

In order to check signature using the public key, a rough form of “decryption” is utilized. The result of the process is not true decryption but a “hash” (i.e. where hash is generally understood as a digital algorithm or fingerprint of data which ensures authenticity) of the original data in the byte array. Since the “hash” cannot be “unhashed”, the original message is hashed. If the hash of the original message matches the “decrypted” hash then the public key is associated with the private key. FIG. 7 illustrates how microprocessor 200 generates a SIGNATURE for financial card 17 using the conventionally known secure hash algorithm (SHA). A Java applet 300 hashes a DATA message 304 and then passes DATA message 304 to a card API 302 as shown. The card API 302 then encrypts the hashed DATA message using the private key along with the hashed data as shown and returns a SIGNATURE message 306 to applet 300. Applet 300 in turn provides SIGNATURE message 306.

Financial card 17 also utilizes commercially available programs which offer a high degree of protection against tampering and reserve engineering attacks. The Cloakware™'s program translation tool, or encoder, works at the source code level, allowing microcontroller 200 to perform deep structural transformations to on-card software to generate a secure or “cloaked” program. The Cloakware program cascades into a failure mode which inherently limits the usefulness of any changes made to the operating software and deters potential coding intervention.

Also, transport layer security (TLS) is used to secure privacy and data integrity of messages, during client-server communication (i.e. while data is being exchanged between two communicating parties over a non-secure network such as the Internet). As is conventionally known, the TLS protocol consists of several layers, the lowest being the TLS Record Protocol and the highest being the TLS Handshake Protocol. This level of security is especially necessary when financial card 17 is utilized within e-business applications (e.g. on-line transactions). Security can be further enhanced by enabling the applicable server a CertificateRequest the Handshake Protocol, requiring client send a CertificateVerify message to the server.

In summary, fund transfer system 10 provides individuals with the ability to remotely authorize the issuance of a financial card to another individual at a geographically remote location and for recipient 14 to select a unique PIN number to activate a secure and fully operational financial card 17. Since fund transfer system allows sender 12 to provide recipient 14 with funds even if recipient does not have personal identical papers or an active financial account, it does not have the practical limitations associated with traditional “wire” transfers.

Since financial card 17 can be issued to recipient 14 without requiring authentication other than the verification ID protocol (i.e. a specific question answer sequence provided by the sender 12) recipient 14 is provided with an fully anonymous negotiable instrument at the time of issue while eliminating the trail of data in the course of usage of financial card 17 which is typically left by consumers every time a credit card is used to purchase an product or service.

Also, recipient 12 will find financial card 17 more convenient to carry than cash or travellers cheques and near instantaneous receipt of funds can be achieved within system 10. Recipient 12 will be able to use financial card 17 within pre-existing merchant account systems already setup to accept credit/debit payment (e.g. MasterCard, Visa, American Express, Diners Club etc.) Also, the explosion of consumer purchases over the Internet has created a substantial need for a financial card which do not expose consumers to the danger of having credit card information stolen over the Internet and which can be used for both Internet and non-Internet transactions.

Further, the simplicity of fund transfer system 10 lends itself to lower operational costs and reduced operator errors in comparison to those of conventional fund transfer systems such as “wire” transfer services. Other systemic advantages for the issuer include the absence of the need to determine the level credit risk through a credit check for sender 12 or recipient 14. Also there is no need for special or complicated installations at merchant/client locations. It is contemplated that fund transfer system 10 could operate in a completely automated fashion within a conventional ATM network (i.e. without human operators) which would allow recipient to receive a preprogrammed financial card 17 anywhere that an ATM machine is located and further reduce operational costs and operator error.

From an issuer's financial market point of view, fund transfer system 10 provide the ability to increase profits from currency exchange when user's adopt fund transfer system on a large scale. Further, profits could be made from charging recipient 14 a flat fee for the issuance of financial card 17 depending on the amount of funds transferred (e.g. current pricing indicates that for amounts over $1,500.00 charges of between $25.00 to $45.00 (USD) could be passed onto recipient 14 while still keeping the cost below travellers cheques and wire transfers. Where an increased number of individuals utilize the fund transfer system, there will be additional profits from the associated increase in volume of merchant fees (due to additional merchant point purchases as a result of increased consumer confidence in financial card 17). Also, profits can be realized from related ATM fees due to an increased use of ATM machines for fund transfers. Also, since applicable taxes are levied at the point of purchase for sender 12, concerns of issuance countries can be addressed. Finally, immediate notification and/or completed forms for transactions in excess of $5,000.00 could be sent to the appropriate agencies and/or authorities as required by laws in the United States, Canada and other countries, at the same time that the applicable taxes and fees are levied.

Further, fund transfer system 10 can be utilized within a number of different user scenarios. Examples include the student whose parents wish to keep within a preset budget, the travelling executive put on a set budget by his company, the traveller who requires additional security and who wishes to pre-authorize fund transfer to himself at a destination point (i.e. destination airport), and a stranded traveller, shopper or victim of robbery of theft of personal ID. Accordingly, fund transfer system 10 provides a viable alternative to travellers cheques, credit/debit cards, and “wire” transfers, and allows any person to instantly and electronically transfer currency to any other person even in the case where neither person has a preestablished financial account with the organization, and which will still take advantage of an existing ATM network.

Fund transfer system 10 can specifically provide corporate users with the ability to provide financial management control for employees when travelling away from the office. Fund transfer system 10 allows a corporation to provide employees with the authority to buy and pay for goods and services remotely (i.e. by remotely issuing them cards of predetermined value) while providing direct contact with the financial computer systems at head office (i.e. transactional data could be specifically sent to the corporate computer system every time a purchase using financial card 17 is made etc.)

Specifically, the financial transactions of a company's employees can be monitored for real time inventory, distribution, and cash flow control purposes (i.e. to implement spending limits etc.) Accordingly, fund transfer system 10 provides a corporate client with the ability to remotely authorize fund transfers as well as to integrate employee transactions (buy/sell) in real time with the corporation's general ledger with a minimum of delay (i.e. for real time accounting and operations). The ability to control and track real-time spending incurred by travelling executives, salespeople and sports teams provides organizations with the ability to conduct immediate reconciliation of expenses through centralized head office accounting departments. Financial card 17 can also be beneficially used within various other types of organizations such as government supplied cards to persons on government programs or within the military where additional security and anonymity can be especially desirable.

It should be appreciated that further application of fund transfer system 10 may be made in the context of tracking missing cards. Specifically, financial card 17 could be provided by including a tracking Global Positioning System (GPS) receiver chip within financial card 17 that would allow for tracking once a card has been reported missing or stolen. It would also be possible to deactivate the stolen card and to reissue a replacement financial card 17 to recipient 14 as is conventionally known. The GPS tracking feature could also be used by default by an individual who wishes to track another individual (e.g. a parent who wants to know where the child is located) to provide an additional security feature.

It should be noted that financial card 17 could be configured to be “rechargeable” for reuse purposes. It is possible that issuers could institute a recycling program for reuse of cards whereby extra bonus points are offered when recipient 14 returns the card. Also, any odd remaining funds left on financial card 17 (i.e. low odd sums) may be converted into cash by the issuer.

Another feature of fund transfer system 10 is that only recipient 14 can access the funds that are located on financial card 17. This feature is advantageous in situations where the act of carrying cash might not be desirable.

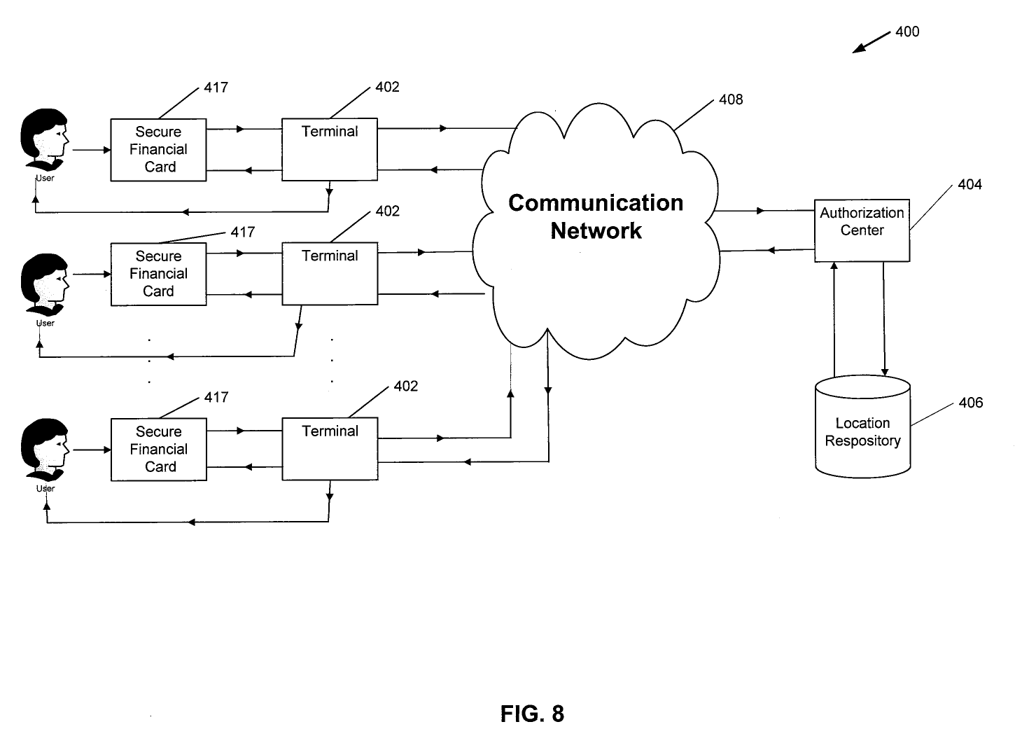

Referring to FIG. 8, illustrated therein is a financial transaction processing system 400 in accordance with another embodiment of the invention.

The financial transaction processing system 400 may be used for automating electronic transfer of funds and authenticating transactions involving financial cards based on the functionality provided by the financial card 417 and the methods described below. The financial transaction processing system 400 may include a plurality of financial terminals 402, at least one authorization center 404, a locations repository 406, a communication network 408, and at least one financial card 417.

In one embodiment, a financial terminal 402 may be an automated teller machine (ATM). In other embodiments, a financial terminal 402 may be a portable electronic point of sale (ePOS) device or a personal computer. Yet in other embodiments, financial terminals 402 may be a combination of different types of financial terminals such as ATMs, ePOS devices and personal computers.

Each financial terminal 402 is configured to receive a financial card 417 and interface the financial card 402 to transfer data between the financial card 402 and the financial terminal 417. Each financial terminal 402 is connected to at least one authorization center 404 that determines whether to allow or deny a transaction and transmits an authorization signal indicating the decision to the originating financial terminal 402. The authorization center 404 has access to a locations repository 406 where geographical position data of each financial card 417 may be stored and used for geographical analysis as described below.

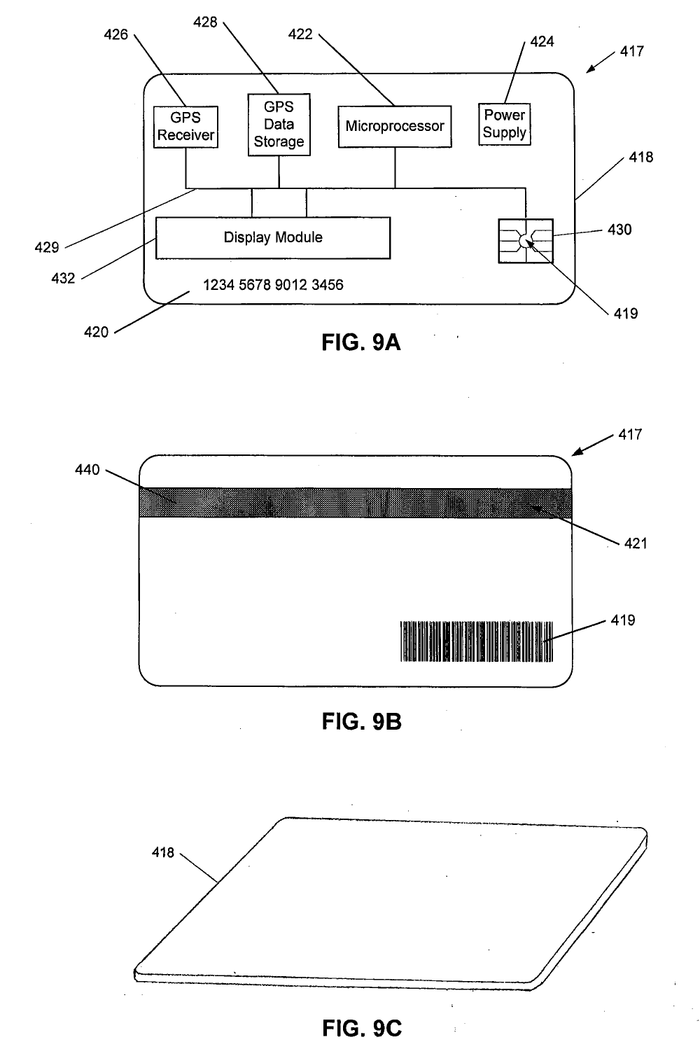

Reference is now made to FIGS. 9A-9C, which illustrate an exemplary embodiment of the financial card 417. The financial card 417 includes a card body 418 made of a thin sheet material, which may be sized and shaped to resemble a standard banking card or credit card capable of being received in a card reader of a financial terminal 402. Financial terminals 402 may be existing financial terminals such as Automated Teller Machines (ATMs) and other point of sale electronic payment processing terminals. In other embodiments, it is contemplated that the physical dimensions of the financial card 417 may differ to ensure that it is capable of being received in a card reader in a financial terminal 402.

The financial card 417 has a card data storage device 430 for storing identification data. The card data storage device 430 may be embedded in or otherwise secured to the card body 418. The identification data is used for identifying the card to the financial terminal 402 and the authorization centre 404. The identification data may include identifying information about the card that may be used to authenticate the card such as the card issuer, card number, and pre-selected personal identification (PIN) number. In some embodiments, identification data may also include a card public cryptographic key for the financial card 417.

The financial card 417 has a geographical positioning device embedded in or otherwise secured to the card body 418, which may be used to determine the location of the financial card 17. In the embodiment shown, the geographical positioning device comprises a Global Positioning System (GPS) receiver 426, which can receive GPS signals sent from a constellation of global positioning satellites orbiting the planet. The GPS receiver 426 may be a transceiver, which transmits signals to the GPS satellites in addition to receiving the GPS signals.

The financial card 417 also has at least one microprocessor 422 that may be used to process the received GPS signals to generate geographical position data indicative of a geographical position of the financial card 417. The geographical position data generally includes a longitude value, a latitude value and a time value. The geographical position data may be used to perform locational fraud detection method as described below. The geographical position data may also be used to strengthen the security of the communication between the financial card 417 and the financial terminal 402.

The financial card 417 may include a GPS data storage device 428 for storing the generated geographical position data. A data bus 429 facilitates exchange of data between the microprocessor 422, GPS receiver 426, and GPS data storage 428. It is contemplated that the GPS data storage device 428 may be a logical partition of the card data storage device 430.

In some embodiments, a single microprocessor can be used to perform both the encryption and generating of geographical position data. In other embodiments, a dedicated microprocessor for cryptography (e.g. a cryptoprocessor) may be used for encryption while another microprocessor may be used for generating geographical position data. For example, the microprocessor 422 may be a 32-bit, 5 MHz IBM RISC processor.

The financial card 417 has at least one communication interface for communicating with the card reader for communicating the identification data and geographical data to authenticate the card to the financial terminal 402 and authorization center 404. For example, a communication interface could be contact surface 419 of ISO 7816 interface integrated circuit card (ICC), also referred to as a “smart chip” developed by EMVCo LLP. The financial card may have more than one communication interface to permit backward compatibility with card readers in older financial terminals. For example, one of the communication interfaces could be a magnetic strip 421 electronically encoded with data, which may be accessed by appropriate magnetic strip card readers. Alternatively, communication interface may be contactless, for example by using radio-frequency identification (RFID) technology.

The financial card 417 may also have a power interface which may be configured to allow the financial card to draw power through the power interface when the financial card is received in a financial terminal. In the exemplary embodiment, the contact surface 419 of ISO 7816 interface ICC also functions as the power interface in addition to being a communication interface. Power could be provided to the card through the contact surfaces 419 of the ICC.

The financial card 417 may also have a card based rechargeable power supply 424 to temporarily power the card such that the card may be operable even if power is not being received through the power interface. The card based rechargeable power supply 424 may be recharged when power is received through power interface.

The financial card 417 may also include an optional display device 432 secured to the card body 418, which may be used to display information such as remaining balance, geographical position data, or advertising information.

In other embodiments, the microprocessor 422 may be configured to output display information to a peripheral display device through the communication interface. A peripheral display device could be located on a financial terminal 402. In this embodiment, a user of the financial card 417 may be able to view geographical position data and other display information on the peripheral display device.

The financial card 417 may also include identifying indicia carried by the card body 418 for identifying the card. The identifying indicia may be used to identify the associated financial card 417 to various components of the financial transactions processing system 400 such as the financial terminal 402, the authorization center 404, and the locations repository 406.

The identifying indicia may comprise a first unique card number 420, which may be embossed on the card body 418 as shown in FIG. 9A. The card number 420 may also be represented in a barcode format as shown in FIG. 9B. The barcode format may be advantageous in some situations since the identifying indicia represented in this format may not be readily visually discernable to prying eyes thereby deterring unauthorized dissemination of the identifying indicia. The first card number 420 may also be stored in the card data storage 430 so that it is machine accessible.

The identifying indicia may also comprise a second card number mapped to the first card number 420. The second card number may be encrypted and stored within the card data storage 430 so that it is machine accessible. The mapped pair of the first card number 420 and the second card number may also be stored in the authorization center 404. In some embodiments, the second card number may be assigned by the manufacturer of the card data storage device. Whenever a financial transaction is initiated, the first card number 420 and the second card number will be communicated to the authorization center 404. If the pairing of the first card number 420 and the second card number does not match up with the corresponding pair of numbers stored in the authorization center, the transaction may be flagged as potentially fraudulent and denied. For example, if a transaction request is received with a particular first card number 420 and a particular second card number, but the pairing of the two numbers is different from the pairing in the authorization center 404, the transaction may be flagged as potentially fraudulent and denied. This is advantageous because it would require a potential eavesdropper to obtain both the first card number 420 and the second card number in order to pass this fraud detection check. Since only the first card number 420 may be shown on the surface of the card body, it is more difficult for a casual observer to obtain both the first card number and the second card number stored in the card data storage device.

Referring now to FIG. 9B, where the back of the respective financial card 417 is shown in an exemplary embodiment, the back side of the financial card 417 may include a magnetic strip 440, which can be read by appropriate readers. The magnetic strip may contain necessary information to process some financial transactions to allow for backward compatibility with older versions of existing financial terminals 402.

The GPS receiver 426 receives GPS signals broadcasted by a constellation of GPS satellites. The received GPS signals are converted using the microprocessor 422 to a more user-friendly form of latitude and longitude and combined with a time value to generate geographical position data. The geographical position data may be analyzed as part of the locational analysis to attempt to detect potentially fraudulent transactions. Geographical position data may also be used to strengthen the encryption of the communication between the financial card 417 and the financial terminal 402 as explained below.

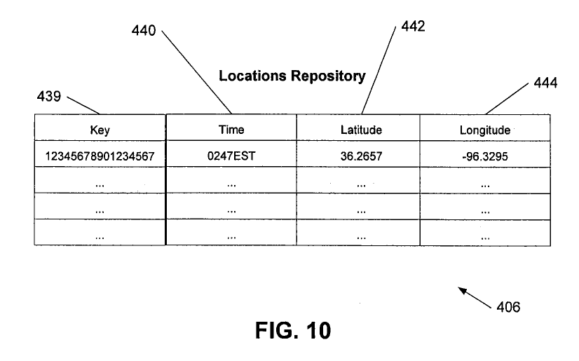

Reference is now made to FIG. 10, where the contents of the locations repository 406 are illustrated in an exemplary embodiment. The locations repository 406 includes a unique database “key” field 439, the value of which is unique to each financial card 417, such as the unique card number 420. The locations repository also has a time data field 440, latitude data field 442, and a longitude data field 444. The time data field 440 records the time at which the longitude and latitude co-ordinates for the financial card are recorded. The latitude field 442 records the latitude measurement and the longitude field 444 records the longitude measurement. The locations repository 406 database is updated periodically to ensure that the information on the database is sufficiently accurate.

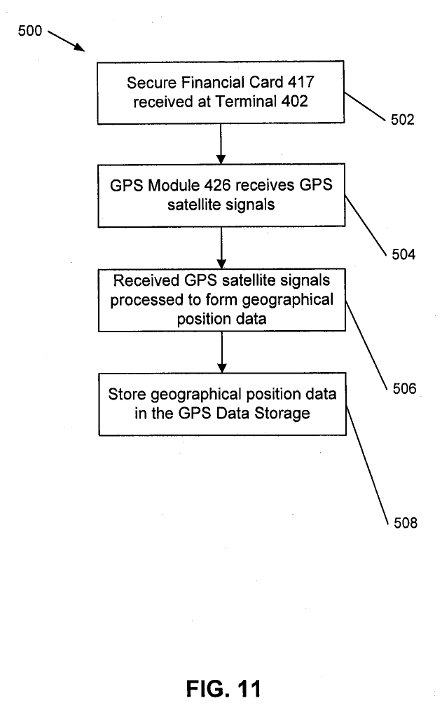

Reference is now made to FIG. 11, where a flowchart illustrating a location determination method 500 is shown in an exemplary embodiment. The location determination method 500 may be engaged at every instance where the financial card 417 is used at a financial terminal 402. Method 500 begins by step 502 where the financial card 417 is received at a financial terminal. In step 504, power is provided to the GPS module comprising the GPS receiver 426 and the microprocessor 422, through the power interface 423 by the financial terminal 402. Once powered, the GPS receiver 426 receives GPS signals from the constellation of GPS satellites. The received signals are processed by the microprocessor 422 to generate geographical position data by step 508. The geographical position data includes latitude, longitude and a time when the data was sampled. In step 508, the sampled data is stored at the GPS data storage 428. In one embodiment, each time a GPS sample is sampled, the previous sample stored in the GPS data storage is overwritten.

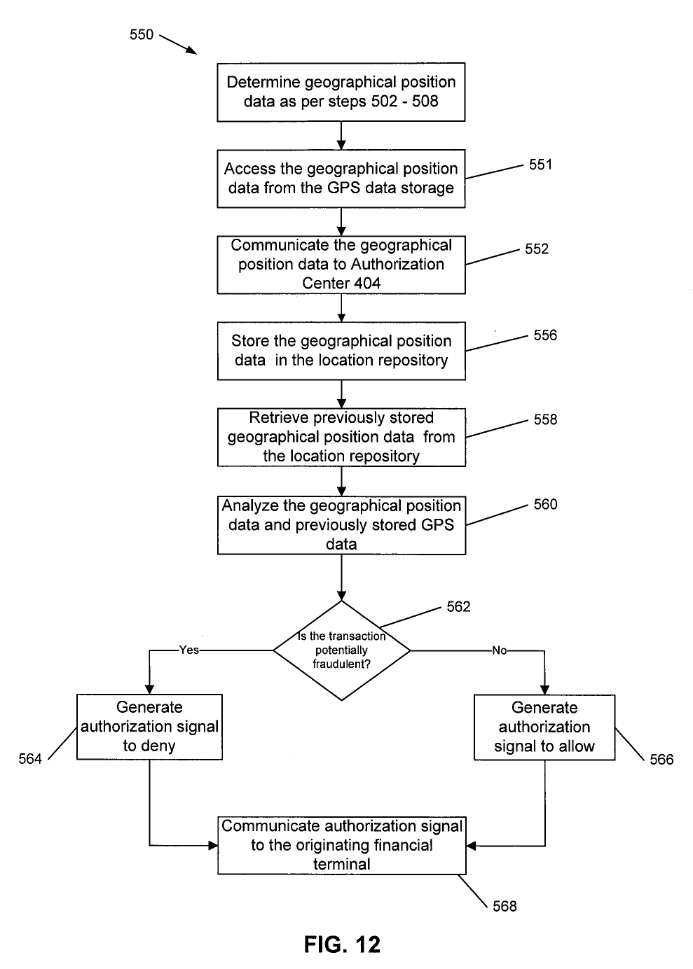

The financial card 417 as described herein provides the user of the card, the issuing institution and the retail institution at which a financial transaction is made with added levels of security to protect against fraudulent transactions. The methods described with respect to FIGS. 12-15 show the steps entailing the additional fraud detection methodologies that may be employed by the system 400.

Reference is now made to FIG. 12, where a flowchart illustrating the steps of a locational fraud detection method 550 is shown. Locational fraud detection method 550 is a method by which transactions are reviewed and analyzed to determine whether they should be approved based on geographic data such as the dynamic geographical position data obtained from the GPS module 426 in a financial card 417.

When the financial card 417 is received at a financial terminal 402, geographical position data may be generated by following the steps indicated by steps 502-508 of method 500 in FIG. 11. The geographical position data is retrieved from the GPS data storage 428 on the financial card 417 by step 551. The retrieved geographical position is communicated to the authorization center 404 over the communication network 408 by step 552. This communication may be encrypted to discourage unauthorized parties to eavesdrop on the communication. Once received at the authorization center 404, the geographical position data may be stored in the locations repository 406. To control the amount of storage required by the locations repository database, in some instances, the received geographical position data may overwrite an older location information related to the financial card 417 that is not required by the authorization center 404 to authenticate the transaction. The authorization center 404 may retrieve previously stored geographical position data related to the financial card 417 from the locations repository by step 558.

Method 550 then proceeds to step 560, where based upon the current time and location data associated with the current usage of the financial card 417 (based on the location of the financial terminal 402), the data is analyzed against the previously recorded time and geographical data. The analysis of the time and geographical data will factor in the pattern of usage of the card and will look for indications of potentially fraudulent activity. Where indications of potentially fraudulent activity are present, a notification may be provided for the user of the card to contact the authentication center 404, or the transaction may be denied to ensure that at least some potentially fraudulent transactions are not permitted. Based on data that is present in the database, computations may be performed to determine whether there exists the potential for any fraudulent activity. Conventional checking procedure that are currently present to detect fraudulent activity are also employed; for example if a card is being used away from its normal geographic area of usage such as a new country that the card has not been used previously, the usage activity may then be flagged as potentially fraudulent. Also, where the geographical position data and time when compared indicate a pattern of usage that may not fit with conventional travel patterns, such usage may also be flagged as being potentially fraudulent. For example, if the previously stored geographical position data indicates uses of the card in a similar geographic area within an acceptable time frame such as use at a gas station and a nearby restaurant within a short period of time, the transaction will not be flagged as potentially fraudulent by the locational analysis. However if the same card is being attempted to be used in another locale that would be impracticable or impossible to reach within the time that has elapsed, the attempted use may be flagged as being potentially fraudulent. Location fraud detection method 550 by step 562 may make a determination regarding whether a requested transaction should be flagged as being potentially fraudulent. An authorization signal, either to deny the transaction as indicated by step 564, or allow the transaction as indicated by step 566 is generated. The generated authorization signal is communicated to the originating financial terminal 402 by step 568.

The location fraud detection method 550 may be used with other fraud detection methods. For example, a financial terminal may assign a unique identifier to each transaction. This identifier may be used to detect potentially fraudulent transaction. For example, if the authorization center receives a request with a transaction identifiers which had previously be used, the authorization center may flag the transaction as a potentially fraudulent transaction since it is possible that the transaction originated from an unauthorized terminal or the transaction is replay attack as described below.

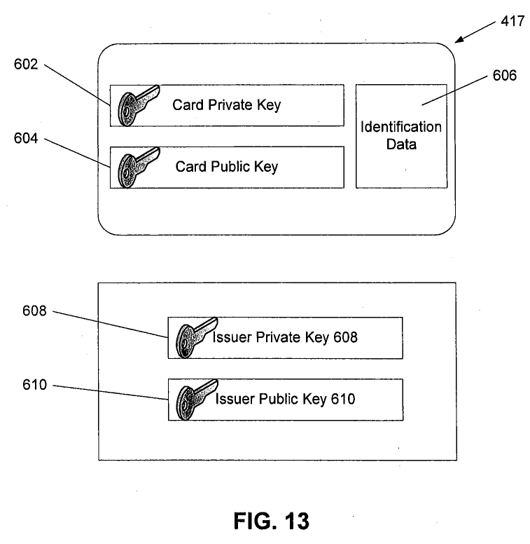

Referring now to FIGS. 13-15, the present invention is also directed to a system and a method for strengthening encrypted communications between a financial card and a financial terminal to make the communication between the financial card and more difficult for eavesdroppers to commit fraud by recording the communication and replicating the information onto an unauthorized financial card. Card issuers currently use a number of anti-counterfeiting technologies to defend against such frauds. One common anti-counterfeiting method is use static data authentication (SDA) to discourage eavesdropping of the communication between financial card and the financial terminal.

Reference is now made to FIG. 13, where a block diagram illustrates the cryptographic components used in authorizing transactions in further detail. The financial card 417 has associated with it, a card private key 602, a card public key 604, and identification data 606. The issuer of the financial card 417 has associated it, an issuer private key 608, and the issuer public key 610. In static data authentication, identification data 606 is provided for each secured financial card 417 which includes relevant account information such as the account number and expiration date. The identification data 604 is also encrypted by the issuer private key 608 and stored in the card data storage 430 on the payment card. It is not practically possible for a party to decrypt the encrypted identification data without having the card issuer's public key 610.

When a financial card 417 is received at a terminal 402, terminal retrieves the encrypted identification data from the financial card 417. To decrypt the retrieved identification data 604, it is necessary for the terminal to obtain public key 610 from the issuer of the card. The terminal can either request for the issuer's public key 610 from the issuer directly or through a chain of certification authorities (CA) as defined by known public key infrastructure (PKI) standards. The means to securely retrieve an authentic issuer public key is well known to those skilled in the art. Once the card public key 604 is retrieved, the identification data is decrypted and user authentication process may commence. The use of the public key 604 and private key encryption algorithm is advantageous since only the issuer processes the issuer private key 610 necessary to encrypt the identification data 606. As such, a party without the issuer private key 608 may not modify the identification data on the financial card 417.

The terminal attempts to identify the authenticity of the user of the financial card 417 by requiring the user to input information that only an authorized user of the financial card 417 should know. This information is verified against the information contained in the identification data to determine if a user should be permitted to use the card. In one embodiment, the identification data will contain a personal identification number (PIN), which is a series of pre-selected numbers. Once the identification data on the card is decrypted using the issuer's public key, and the PIN is retrieved, the user will be prompted to enter a PIN. If the PIN entered matches the PIN retrieved from the card, the user is assumed to be a person authorized to use the financial card 417. In addition to, or in place of the PIN authentication process, the terminal 402 may use other ways to authenticate a user of the financial card 417. For example, the terminal 402 may ask a series of security questions. If the user is able to answer a certain amount of questions correctly, the user will be assumed to be a person authorized to access the financial card 417. The questions may be similar to biogenetic authentication tests where the questions relates to personal information that is not easily obtained through identify theft. This could include personality-based questions such as a person's favorite color, favorite food, etc. If such questions are employed, the authorized person using the card must have provided the information prior to the security card 417 being issued.

Despite static data authentication protocol, it is still possible for an unauthorized party to eavesdrop on the communication between the terminal and the financial card 417. The information obtained by such unauthorized means may form the basis of a “replay attack”. Essentially, a replay attack occurs when an unauthorized party repeats an otherwise valid data transmission in hopes of deceiving the receiving party into believing that the transmission originated from an authorized party. One way to prevent this type of attack is to combine dynamic data with the identification data so the combined transactional data is always unique within a reasonable time frame. The receiving party may then examine the unique data to determine if that data did indeed originated from an authorized source.

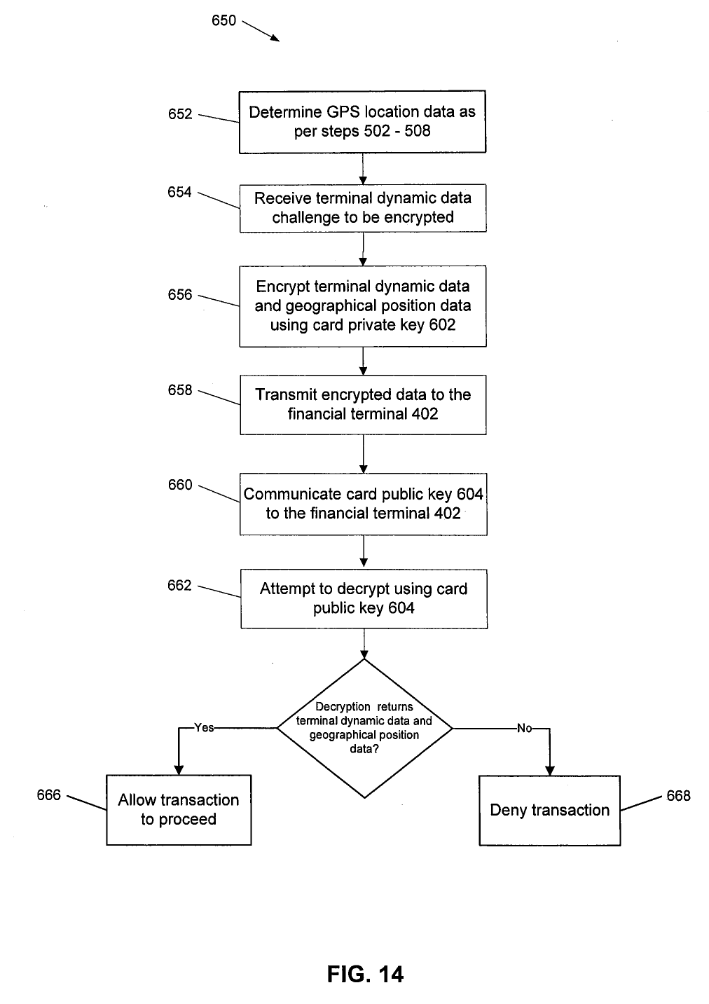

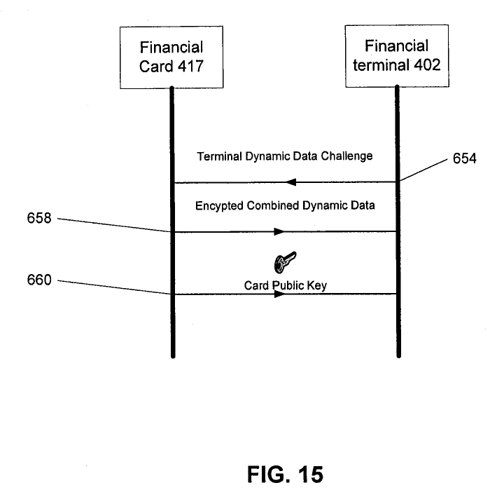

Reference is now made to FIGS. 14 and 15, where the steps of an improved authentication method 650 are shown in an exemplary embodiment. Method 650 is by step 652, where geographical position data is determined using steps 502 to 508 of method 500. This geographical position data is unique to a particular time and location therefore used as card dynamic data. In step 654, the financial card 417 receives terminal dynamic data generated by the financial terminal. The terminal dynamic data acts as a challenge to the financial card. The financial card 417 responds by encrypting the terminal dynamic data, and card dynamic data using the card private key 602 by step 656. The encrypted combined dynamic data is communicated to the financial terminal by step 658. In step 660, the financial terminal receives the card public key 604 from the financial card. The secure retrieval of card public key 604 from the financial card 417, for example through a chain of certification authorities, is known to those skilled in the art. In step 662, the terminal attempts to decrypt the received encrypted combined dynamic data using the card public key 604. If the decryption process returns the expected card dynamic data and terminal dynamic data, financial terminal 402 authenticates that the source of the data as the financial card 417, since only the financial card 417 has the unique card private key 602 necessary to have encrypted the data. The transaction is then allowed to continue as indicated by step 666. If the decrypted value is not the expected card dynamic data and the terminal data, the financial terminal may assume that the card is potentially a forgery and deny the transaction as indicated by step 666. It is contemplated that some steps need not be performed in the particular order for the method to be effective. For example, the financial terminal may retrieve the card public key 604 prior to the geographical position data being generated by step 654.

As will be apparent to those skilled in the art, various modifications and adaptations of the method and system described above are possible without departing from the present invention, the scope of which is defined in the appended claims.

1. A financial card comprising:
a) a card body configured to be received in a card reader of a financial terminal;
b) a card data storage device secured to the card body for storing identification data for identifying the financial card, the identification data being accessible by the card reader when the card body is received in the card reader;
c) a GPS receiver secured to the card body for receiving GPS signals from GPS satellites;
d) a microprocessor secured to the card body and coupled to the GPS receiver for processing the GPS signals to generate geographical position data indicative of a geographical position of the card body; and
e) a communication interface secured to the card body for providing the card reader with access to the geographical position data when the card body is received in the card reader.

2. The financial card of claim 1, wherein the card data storage device comprises an integrated circuit card (ICC), and the communication interface comprises an electrical contact pad on the integrated circuit card configured to electrically connect with electrical contracts in the card reader when the card body is received in the card reader.

3. The financial card of claim 1, wherein the card data storage device comprises an encodable magnetic strip, and the communication interface comprises an interface on the magnetic strip.

4. The financial card of claim 1, further comprising a GPS data storage device secured to the card body and coupled to the microprocessor for storing the geographical position data.

5. The financial card of claim 4, wherein the card data storage device and the GPS data storage device are formed by logical partitioning of a single data storage device embedded in the card body.

6. The financial card of claim 1, wherein the card data storage device is configured to store a cryptographic card private key and a card public key correlated therewith, and wherein the microprocessor is configured to encrypt the geographical position data using the card private key and to transmit the encrypted geographical position data to the financial terminal to verify the authenticity of the financial card.

7. The financial card of claim 6, wherein the financial terminal is configured to verify the authenticity of the financial card by decrypting the encrypted geographical position data using the card public key to recover the geographical position data.

8. The financial card of claim 1, further comprising a power interface secured to the card body configured to receive power from the card reader and for powering the GPS receiver and the microprocessor when the card body is received in the card reader.

9. The financial card of claim 8, wherein the power interface comprises an electrical contact pad on the integrated circuit card configured to electrically connect with electrical contracts in the card reader when the card body is received in the card reader.

10. The financial card of claim 8, further comprising a rechargeable power supply secured to the card body, the rechargeable power supply being rechargeable via the power interface when the card body is received in the card reader.

11. The financial card of claim 10, further comprising an electronic display device secured to the card body, the display device being configured to display messages.

12. The financial card of claim 1, wherein the microprocessor is configured to output display messages to a peripheral display device through the communication interface.

13. The financial card of claim 12, wherein the peripheral display device is located on a financial terminal.

14. The financial card of claim 1, further comprising identifying indicia carried on the card body to identify the financial card, the identifying indicia being accessible by the card reader.

15. The financial card of claim 14, wherein the identifying indicia comprises a first card number displayed on the card body, and a second card number stored in the card data storage device, the second card number being uniquely mapped to the first card number.

16. The financial card of claim 14, wherein the second card number is assigned by a manufacturer of the card data storage device.

17. A method for detecting a potentially fraudulent financial transaction, comprising:
a) receiving a financial card in a card reader of a financial terminal, the financial card having a GPS module for generating geographical position data indicative of the current geographical location of the financial card;
b) accessing the geographical position data from the GPS module;
c) communicating the geographical position data to an authorization center;
d) analyzing the geographical position data and, based on the analysis of the geographical position data, generating an authorization signal indicating whether the transaction is potentially fraudulent; and
e) denying the transaction based on the authorization signal if the transaction is potentially fraudulent.

18. The method of claim 17, wherein the geographical position data is generated by receiving GPS signals from GPS satellites and processing the GPS signals using a microprocessor on the financial card.

19. The method of claim 17, wherein the geographical position data is stored in a locations repository database so that the geographical position data may be used for at least one of i) analysis of succeeding transactions and ii) generating an audit trail.

20. A method for strengthening encrypted communications between a financial card and a financial terminal, the method comprising:
a) engaging the financial card in a card reader of the financial terminal, the financial card having a GPS module for generating geographical position data indicative of the current geographical location of the financial card and a data storage device for storing card public key an a card private key correlated therewith;
b) generating the geographical position data using the GPS module;
c) transmitting a card public key from the financial card to the financial terminal;
d) receiving terminal dynamic data from the financial terminal;
e) encrypting the geographical position data and the terminal dynamic data using the card private key to generate encrypted combined dynamic data; and
f) transmitting the encrypted combined dynamic data to the financial terminal, wherein the terminal is configured to verify the authenticity of the financial card by decrypting the received encrypted combined dynamic data using the card public key to recover the terminal dynamic data and the geographical position data.

21. The method of claim 20, wherein the GPS module comprises a GPS receiver and a microprocessor and the geographical position data is generated by receiving GPS signals from GPS satellites using a GPS receiver and processing the GPS signals using the GPS receiver and the microprocessor.

22. The method of claim 20, wherein the card public key is encrypted using a card issuer private key and the financial terminal may decrypt the card public key when the financial terminal has an authentic card issuer public key.

23. The method of claim 22, wherein the financial terminal is configured to authenticate the card issuer public key through a trusted certificate authority.

24. A system for authenticating electronic financial transactions, comprising:
a) a plurality of financial cards, each of the financial cards having a card data storage device for storing identification data, and a GPS module for generating geographical position indicative of a current geographical position of the financial card;
b) a plurality of financial terminals, each of the financial terminals having a card reader configured to receive one of the financial cards and access the identification data and geographical position data associated therewith; and
c) at least one authorization center connected to the plurality of financial terminals, the authorization center being configured to:
i) receive transactional data associated with a financial transaction, the transactional data including the identification data and the geographical position data for the particular financial transaction involving a particular financial terminal and a particular financial card, and
ii) for each financial transaction, determine whether that transaction is potentially fraudulent based on an analysis of the geographical position data for that transaction and previously stored geographical position data related to the particular financial card.

25. The system of claim 24, wherein each financial card further comprises a card private key and a corresponding card public key, and wherein:
a) the card public key is transmitted to the financial terminal;
b) the microprocessor is configured to encrypt the geographical position data using the card private key and to transmit the encrypted the geographical position data to the financial terminal; and
c) the financial terminal is configured to decrypt the transmitted data using the card public key to verify the authenticity of the financial card.

26. The system of claim 25, wherein the card public key is encrypted using a card issuer private key and the financial terminal may decrypt the card public key when the financial terminal has an authentic card issuer public key.

27. The system of claim 26, wherein the financial terminal is configured to authenticate the card issuer public key through a trusted certificate authority.
